(19) United States
(12) Patent Application Publication
(10) Pub. No.: US 2016/0198726 A1
(43) Pub. Date: Jul. 14, 2016

(54) Baking Tray

(71) Applicant: Sharron E. Cochran, Savannah, GA (US)

(72) Inventor: Sharron E. Cochran, Savannah, GA (US)

(21) Appl. No.: 14/735,263

(22) Filed: Jun. 10, 2015

Related U.S. Application Data
(60) Provisional application No. 62/102,181, filed on Jan. 12, 2015.

(51) Int. Cl. A21B 5/02

(52) U.S. Cl. CPC A21B 5/026

(57) ABSTRACT

A baking tray for holding ice cream cones or similar objects. The baking tray includes a rectangular panel having a pair of legs extending from opposing sides thereof, wherein the legs serve to dispose the rectangular panel in a horizontal orientation and in an elevated position. The rectangular panel further includes openings thereon arranged in a grid pattern, wherein the openings are sized to receive a portion of an ice cream cone or similar object therein so as to support the ice cream cones in an upright orientation. The rectangular panel also includes a pair of handles extending from opposing sides of the rectangular panel to assist the user when transporting the baking tray.

### CROSS REFERENCE TO RELATED APPLICATION

This application claims the benefit of U.S. Provisional Application No. 62/102,181 filed on Jan. 12, 2015. The above identified patent application is herein incorporated by reference in its entirety to provide continuity of disclosure.

### BACKGROUND OF THE INVENTION

### Field of the Invention

The present invention relates to baking trays. More specifically, the present invention provides a baking tray adapted to hold a plurality of ice cream cones in an upright orientation for baking. The baking tray comprises a rectangular panel having a pair of legs extending perpendicularly therefrom, wherein the legs serve to dispose the rectangular panel in a horizontal orientation elevated from a support surface. The baking tray includes a plurality of openings thereon arranged in a grid pattern wherein the openings are used to hold ice cream cones therein.

Cone cakes are baked goods wherein a conventional ice cream cone is filled with cake batter and is then baked in the conventional manner. Cone cakes provide the user with an edible holder for the cake and provide the texture of a cake combined with the crunchiness and sweetness of an ice cream cone. Cone cakes are a unique baked good that provides people with a tasty and portable treat.

When preparing cone cakes, it can be difficult to support a number of cones in an upright orientation. Baking cone cakes can be difficult as ice cream cones having a conical shape, are top heavy, and are not easily supported in an upright position. If the cones are not properly supported and maintained in an upright position, the cones may tilt or shift during baking, causing the cake batter to spill therefrom. While some people use muffin tins to make cone cakes, muffin tins are not sized to hold ice cream cones and may not be effective in supporting the cones in an upright orientation. Thus, a baking tray for baking cone cakes is desired in order to support the cones in an upright orientation during baking.

Devices have been disclosed in the prior art that relate to baking trays. These include devices that have been patented and published in patent application publications. These devices generally relate to baking devices for supporting cones. U.S. Pat. No. 5,860,358, U.S. Pat. No. 5,899,353, U.S. Published Patent Application Number 2013/0209631, U.S. Pat. No. 5,450,785, and U.S. Pat. No. 4,941,585, provide baking apparatuses comprising a plurality of openings or supporting members therein for supporting cones in an upright orientation.

These prior art devices have several known drawbacks. The devices in the prior art fail to disclose a baking tray having a rectangular panel with a pair of legs extending downwardly therefrom and that further includes a pair of handles pivotally secured to the rectangular panel. Further, the devices in the prior art fail to disclose a rectangular panel having legs permanently affixed thereto for supporting the panel in an elevated position relative to a support surface, such as a baking tray.

In light of the devices disclosed in the prior art, it is submitted that the present invention substantially diverges in design elements from the prior art and consequently it is clear that there is a need in the art for an improvement to existing baking tray devices. In this regard the instant invention substantially fulfills these needs.

### SUMMARY OF THE INVENTION

In view of the foregoing disadvantages inherent in the known types of baking trays now present in the prior art, the present invention provides a new baking tray wherein the same can be utilized for providing convenience for the user when baking a plurality of cone cakes in an oven and supporting said cones in an upright position during baking.

It is therefore an object of the present invention to provide a new and improved baking tray comprising a rectangular panel having a pair of legs on opposing sides thereof for supporting the rectangular panel in an elevated position, wherein the rectangular panel further includes a plurality of openings for holding a portion of a cone therein.

It is another object of the present invention to provide a baking tray comprising a pair of pivoting handles on opposing sides thereof for facilitating transportation of the baking tray.

Another object of the present invention is to provide a baking tray comprising a plurality of openings arranged in a grid for supporting a plurality of cones in an upright position during baking.

Yet another object of the present invention is to provide a baking tray comprising a pair of L-shaped legs, wherein the legs include a vertical portion and a horizontal base portion that is adapted to rest against a support surface.

Another object of the present invention is to provide a baking tray that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the baking tray of the present invention.

FIG. 2 shows an overhead view of an embodiment of the baking tray of the present invention.

FIG. 3 shows a side cross sectional view of an embodiment of the baking tray of the present invention.

### DETAILED DESCRIPTION OF THE INVENTION

Reference is made herein to the attached drawings. Like reference numerals are used throughout the drawings to depict like or similar elements of the baking tray. For the purposes of presenting a brief and clear description of the present invention, the preferred embodiment will be discussed as used for supporting a plurality of cones in an upright orientation during baking. The figures are intended for representative purposes only and should not be considered to be limiting in any respect.

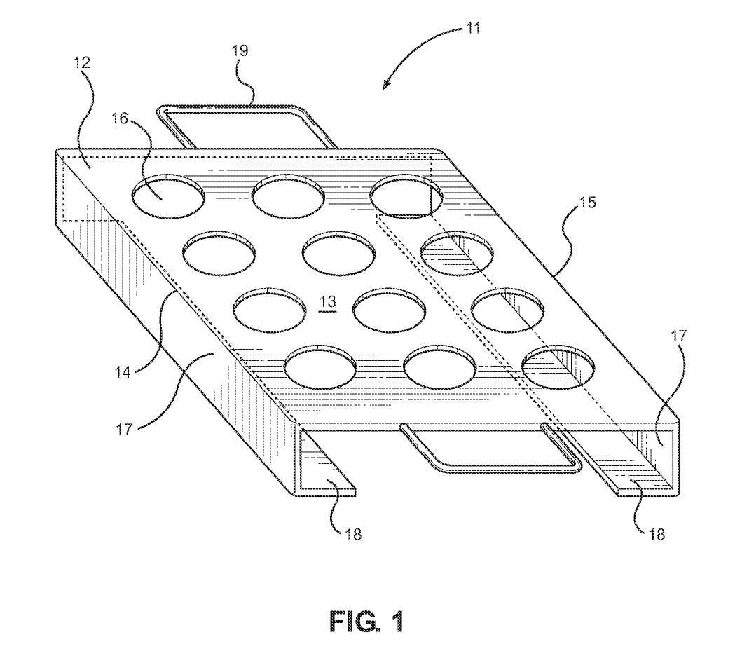

Referring now to FIG. 1, there is shown a perspective view of an embodiment of the baking tray of the present invention. The baking tray 11 comprises a rectangular panel 12 having a first side 14 opposite a second side 15. The rectangular panel 12 is preferably planar and includes a flat upper surface 13. The rectangular panel 12 comprises a plurality of openings 16 thereon, wherein the openings 16 are adapted to receive a portion of an ice cream cone or similar object therethrough. The openings 16 are adapted to support the ice cream cones in an upright orientation during baking.

The baking tray 11 further comprises a pair of legs 17 disposed on opposing sides 14, 15 of the rectangular panel 12. A first leg 17 is disposed on a first side 14 of said rectangular panel 12 and a second leg 17 is disposed on a second side 15 of the rectangular panel 12. The legs 17 may extend along the length of the rectangular panel 12 or may extend from a portion thereof, depending upon the embodiment. The legs 17 extend downwardly from the rectangular panel 12 and are disposed perpendicularly thereto. In this way, the legs 17 serve to position the rectangular panel 12 in a horizontal orientation, wherein the rectangular panel 12 is elevated above a support surface. The legs 17 are shown as having an L-shaped configuration, wherein the legs 17 include a vertical portion extending downward from the rectangular panel 12 and a horizontal base portion 18 that is adapted to rest flush against support surface. The horizontal base portion 18 of the legs 17 helps to stabilize the legs. The legs 17 are preferably rigidly and permanently affixed to the rectangular panel 12 so as to stabilize the baking tray 11.

In some embodiments, the rectangular panel 12 further includes a pair of handles 19 on opposing sides thereof. In the illustrated embodiment, the handles 19 are shown as having a U-shaped configuration, however, in alternate embodiments the handles 19 may have other shapes and configurations. The handles 19 are preferably pivotally attached to the rectangular panel 12 so that the handles 19 can be folded underneath the rectangular panel 12 for storage when not in use. Further, the handles 19 are preferably located on the sides of the rectangular panel 12 not having legs 17 thereon, such that the legs 17 do not interfere with the user's ability to grasp the handles 19.

The baking tray 11 is preferably composed of a heat resistant material suitable for use in an oven, and suitable for exposure to high temperatures, such as temperatures in the range of 300 to 500 degrees Fahrenheit. Thus, the baking tray 11 including the rectangular panel 12, legs 17, and handles 19 may be composed of aluminum or stainless steel, among other suitable materials.

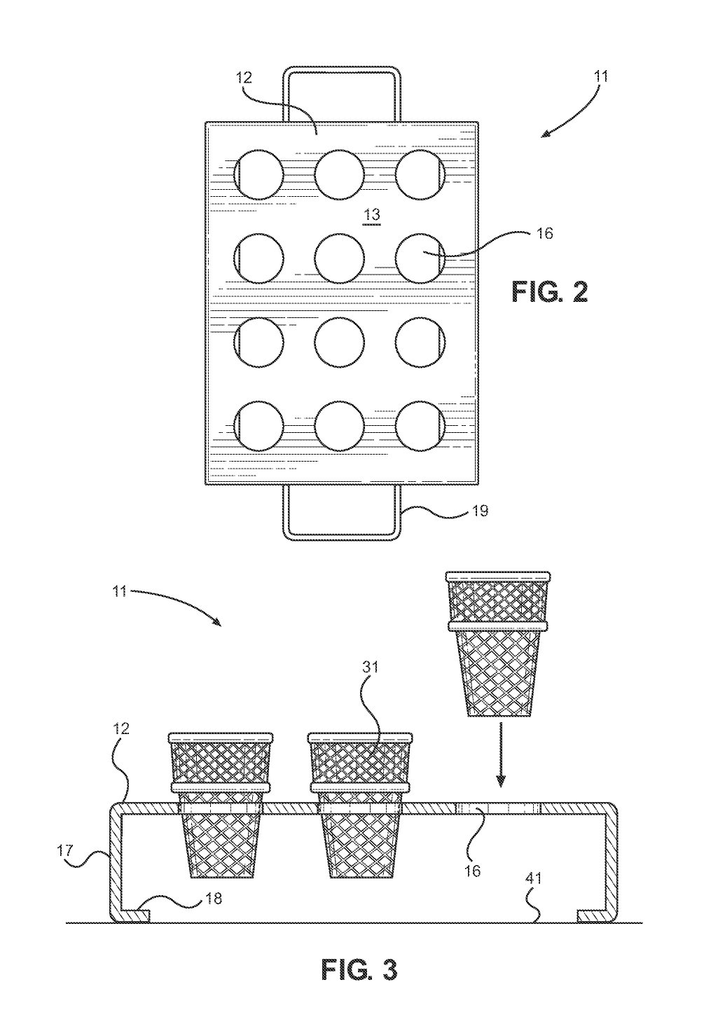

Referring now to FIG. 2, there is shown an overhead view of an embodiment of the baking tray of the present invention. The openings 16 are preferably circular and are sized to receive a portion of an ice cream cone therein. The openings 16 allow a portion of an ice cream cone to extend below the surface of the rectangular panel 12, while a portion of the ice cream cone remains above the rectangular panel. The openings 16 are arranged in a grid pattern and are spaced at a fixed interval. In this way, the openings 16 are arranged in one or more rows and in one or more columns. This helps to ensure that the cones bake evenly and that the cones do not contact one another during baking. Further, the grid pattern helps to utilize the surface area of the rectangular panel 12 for baking numerous cones simultaneously.

Referring now to FIG. 3, there is shown a side cross sectional view of an embodiment of the baking tray of the present invention. In operation, the user can place the baking tray 11 on a baking sheet 41 or other support surface, such as an oven rack. The horizontal base portion 18 of the legs 17 engages the support surface so as to support the rectangular panel 12 in a horizontal position, wherein the rectangular panel 12 is elevated above the support surface. Thus, the user can use the baking tray 11 alone and can place the baking tray 11 on an oven rack, or can use the baking tray 11 in conjunction with a conventional baking sheet.

Ice cream cones 31 or similar objects can be supported within the openings 16 such that a portion of an ice cream cone 31 extends below the rectangular panel 12 and a portion of the ice cream cone extends above the rectangular panel 12. Ice cream cones 31 generally have a conical or tapered shape, and as a result the ice cream cone 31 cannot fully pass through the opening 16 and a portion of the ice cream cone 31 having the same diameter as the opening 16 will be unable to pass through the cone. Thus, the openings 16 help to support the ice cream cones in a stable, upright position during baking, wherein the ice cream cones can be filled with cake batter among other ingredients.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A baking tray, comprising:
a panel having a first side opposite a second side;
a first leg extending downwardly from said first side and a second leg extending downwardly from said second side;
a plurality of openings on said panel adapted to hold a portion of an ice cream cone therein;
a pair of handles affixed to opposing sides of said panel.

2) The baking tray of claim 1, wherein said plurality of openings are circular.

3) The baking tray of claim 1, wherein said plurality of openings are arranged in a grid pattern.

4) The baking tray of claim 1, wherein said plurality of openings are spaced at a fixed interval.

5) The baking tray of claim 1, wherein said panel comprises a planar upper surface.

6) The baking tray of claim 1, wherein said legs extend perpendicularly from said panel.

7) The baking tray of claim 1, wherein said legs extend along the length of said panel.

8) The baking tray of claim 1, wherein said legs comprise a vertical portion extending perpendicularly from said panel and a horizontal base portion parallel to said panel adapted to engage a support surface.

9) The baking tray of claim 1, wherein said panel is composed of stainless steel.

10) The baking tray of claim 1, wherein said pair of handles is pivotally affixed to said panel.

11) The baking tray of claim 1, wherein said panel is substantially rectangular in configuration.
